(19) United States
(12) Patent Application Publication
(10) Pub. No.: US 2018/0033394 A1
(43) Pub. Date: Feb. 1, 2018

(54) HEAD-WEARABLE DISPLAYING AND POWERING SYSTEM

(71) Applicant: Beijing Pico Technology Co., Ltd., Beijing (CN)

(72) Inventors: Xuebing DENG, Beijing (CN); Qiang LI, Beijing (CN); Xiangjun GE, Beijing (CN); Yucai HAN, Beijing (CN); Yuluo WEN, Beijing (CN)

(21) Appl. No.: 15/273,084

(22) Filed: Sep. 22, 2016

(30) Foreign Application Priority Data
Jul. 29, 2016 (CN) 201610619377.4

(51) Int. Cl. G09G 5/00

(52) U.S. Cl. CPC G09G 5/006; G09G 2370/12; G09G 2360/08; G09G 2330/045

(57) ABSTRACT

The present disclosure discloses a head-wearable displaying and powering system, comprising a head-wearable display device and a portable terminal; the head-wearable display device is provided with one communication interface to connect with the portable terminal; The portable terminal, through the communication interface, transmits audio and video data to the head-wearable display device, exchanges data with the head-wearable display device and provides the working power supply to the head-wearable display device. The head-wearable display device may operate normally after being connected to the portable terminal only via one communication interface, needn't occupy too many communication interfaces on the portable terminal and does not limit the application of the portable terminal. As the head-wearable display device acquires the working power supply mainly from the portable terminal, the problem of the overheating of the product caused by the heat generation of the built-in battery is avoided.

### CROSS-REFERENCE TO RELATED APPLICATION

This application claims the benefit and priority of Chinese Patent Application No. 201610619377.4 filed Jul. 29, 2016. The entire disclosure of the above application is incorporated herein by reference.

### FIELD

The present disclosure relates to the technical field of virtual reality, and specifically to a head-wearable displaying and powering system.

### BACKGROUND

This section provides background information related to the present disclosure which is not necessarily prior art.

As virtual reality technology develops, there are more and more types of virtual reality devices. A head-wearable display device used in operation with a portable terminal such as a mobile phone may provide a better user experience. The portable terminal, as a host machine, is connected to the head-wearable display device via a cable. Since the portable terminal is responsible for data processing and the screen of the head-wearable display device is responsible of image display, the portable terminal, as compared with current large-sized host machines, has a better portability and may allow the user to perform virtual reality experience whenever and wherever possible.

This type of head-wearable display device is usually powered in the following manners:

The first manner is using the battery of the portable terminal to power the head-wearable display device. However, the head-wearable display device in the prior art must be connected to the host machine via a plurality of cables, such as using at least one HDMI line to transmit audio and video data, at least one USB line to interact control data and at least one power supply line to supply power. According to such powering manner, many interfaces on the portable terminal are occupied, and many portable terminals cannot satisfy the demand of the head-wearable display device for the number of interfaces.

The second manner is powering the head-wearable display device by an external power supply. However, this method needs to provide an extra power supply interface or a power supply line on the head-wearable display device so that the product looks not pleasant enough. The method further increases the costs and affects portability in user's experience.

The third manner is providing a large-capacity battery in the head-wearable display device, and using the electrical energy stored in the battery to power the head-wearable display device. However, the placement of the battery in the head-wearable display device is apt to cause the device to generate heat, the user's experience is undesirable, and the superheat of the device or undesirable battery quality might threaten the user's personal security.

### SUMMARY

This section provides a general summary of the disclosure, and is not a comprehensive disclosure of its full scope or all of its features.

The present disclosure provides a head-wearable displaying and powering system to solve the shortcoming of the powering manners of the head-wearable display device used in cooperation with the portable terminal in the prior art, so that the head-wearable display device, being connected to the portable terminal only via one communication interface, simultaneously acquires audio and video data signals from the portable terminal, exchanges data signals with the portable terminal and acquires the power supply from the portable terminal. The head-wearable display device does not require an additional power supply interface or power supply line, and only occupies one interface of the portable terminal, and the head-wearable display device obtains the working power supply from the portable terminal, and avoids the problem of the overheating of the product caused by the heat generation of the built-in battery.

To solve the above problem, the present disclosure provides a head-wearable displaying and powering system, comprising a head-wearable display device and a portable terminal; wherein the head-wearable display device is provided with one communication interface through which the head-wearable display device is connected to the portable terminal;

When the head-wearable display device is connected to the portable terminal, the portable terminal, through the communication interface, transmits audio and video data to the head-wearable display device, exchanges data with the head-wearable display device and provides the working power supply to the head-wearable display device.

The advantageous effects of the present disclosure are as follows: in the head-wearable displaying and powering system according to the present disclosure, the head-wearable display device is provided with one communication interface, and connected to the portable terminal via the interface. The head-wearable display device, through the communication interface, simultaneously acquires audio and video data from the portable terminal, exchanges data with the portable terminal and acquires the working power supply from the portable terminal. The head-wearable display device does not require an additional power supply interface or power supply line, makes the product more pleasant and reduces the costs. The head-wearable display device may operate normally after being connected to the portable terminal only via one communication interface, needn't occupy too many communication interfaces on the portable terminal and does not limit the application of the portable terminal. As the head-wearable display device acquires the working power supply mainly from the portable terminal, the problem of the overheating of the product caused by the heat generation of the built-in battery is avoided, the safety of the device is enhanced, and the user's experience is better.

### DRAWINGS

The drawings described herein are for illustrative purposes only of selected embodiments and not all possible implementations, and are not intended to limit the scope of the present disclosure.

FIG. 1 is a functional block diagram of a head-wearable displaying and powering system according to a first embodiment of the present disclosure;

FIG. 2 is functional block diagram of a head-wearable displaying and powering system according to a second embodiment of the present disclosure;

FIG. 3 is a functional block diagram of a wireless charging device in the head-wearable displaying and powering system according to an embodiment of the present disclosure;

FIG. 4 is a structural schematic view of a wireless charging device in the head-wearable displaying and powering system according to an embodiment of the present disclosure;

FIG. 5 is a view showing appearance of a wireless charging device in the head-wearable displaying and powering system according to an embodiment of the present disclosure;

FIG. 6 is a structural schematic diagram of the head-wearable displaying and powering system according to an embodiment of the present disclosure.

Corresponding reference numerals indicate corresponding parts or features throughout the several views of the drawings.

### DETAILED DESCRIPTION

Example embodiments will now be described more fully with reference to the accompanying drawings.

A design idea of the present disclosure is as follows: in view of the shortcoming of the powering manners of the head-wearable display device used in cooperation with the portable terminal in the prior art, the present disclosure provides a head-wearable displaying and powering system. The head-wearable display device is provided with one communication interface, and connected to the portable terminal via the interface. The head-wearable display device, through the communication interface, simultaneously acquires audio and video data from the portable terminal, exchanges data with the portable terminal and acquires the working power supply from the portable terminal. The head-wearable display device does not require an additional power supply interface or power supply line, makes the product more pleasant and reduces the costs. The head-wearable display device may operate normally after being connected to the portable terminal only via one communication interface, needn't occupy too many communication interfaces on the portable terminal and does not limit the application of the portable terminal. As the head-wearable display device acquires the working power supply mainly from the portable terminal, the problem of the overheating of the product caused by the heat generation of the built-in battery is avoided, the safety of the device is enhanced, and the user's experience is better. Furthermore, the present disclosure may further provide a wireless charging device, which powers the portable terminal in a wireless manner, prolongs the duration of the cooperative use of the portable terminal and the head-wearable display device, and does not occupy an interface of the portable terminal.

### Embodiment 1

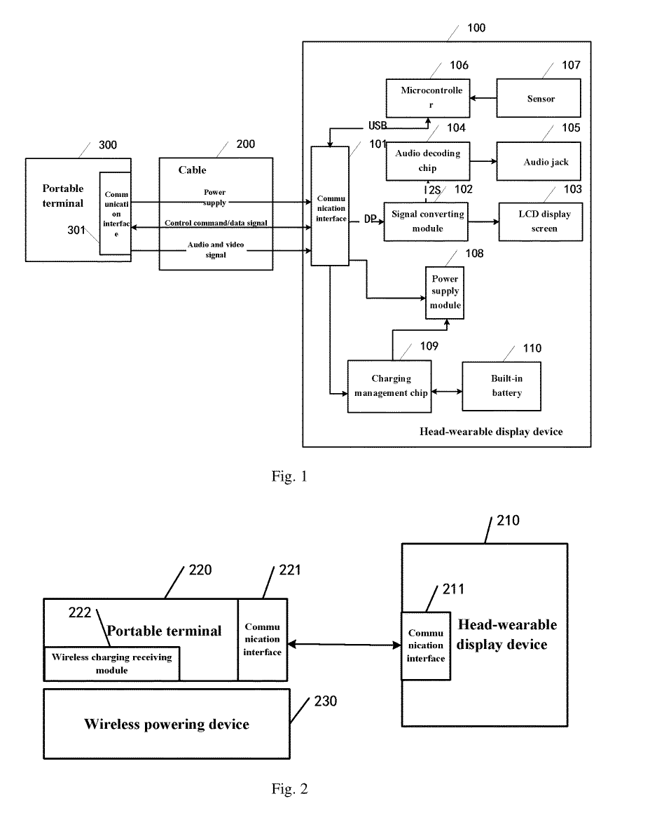

FIG. 1 is a functional block diagram of a head-wearable displaying and powering system according to a first embodiment of the present disclosure. As shown in FIG. 1, the head-wearable displaying and powering system according to the present embodiment comprises a head-wearable display device 100 and a portable terminal 300. The head-wearable display device is provided with one communication interface 101 which may be connected to a communication interface 301 of the portable terminal 300 via a cable 200 to achieve connection of the head-wearable display device 100 and the portable terminal 300. Through this connection, the portable terminal 300 may simultaneously transmit audio and video data to the head-wearable display device 100, exchange data with the head-wearable display device 100 and provide the working power supply to the head-wearable display device 100.

In the present embodiment, the communication interface 101 disposed on the head-wearable display device 100 is a USB Type-C interface, and the portable terminal 300 is a smart mobile phone or flat panel computer having a USB Type-C interface. The communication interface 101 may be a cabled USB Type-C male plug and may be inserted into a USB Type-C female receptacle disposed on the portable terminal 300.

The USB Type-C interface standard is one type of USB 3.1 standard, possesses four pairs of differential signals, enables full duplex communication and supports 5V/20 A at most. USB Type-C may convert some or all differential signal channels therein to Displayport signal channels. If there are still remaining differential signals, they may be used for USB data transmission. Through the USB Type-C interface, the portable terminal 300 may supply power to the head-wearable display device 100 with a larger current, and the USB Type-C interface may transmit a Displayport audio and video signal and USB data signal simultaneously. A signal converting module in the head-wearable display device 100 may convert the received Displayport signal into a video signal and an audio signal needed by a LCD display screen 103 and an audio jack 105. An audio decoding chip 104 is used to decode the audio signal, and a microcontroller 106 is responsible for USB signal interaction between the head-wearable device 100 and the portable terminal 300, e.g., receives a control command sent by the portable terminal 300, and sends data acquired by a sensor 107 to the portable terminal 300.

The head-wearable display device 100 acquires audio and video data from the portable terminal 300, exchanges data with the portable terminal and acquires the working power supply from the portable terminal simultaneously through one USB Type-C interface. The head-wearable display device does not require an additional power supply interface or power supply line, makes the product more pleasant and reduces the costs. As the head-wearable display device acquires the working power supply mainly from the portable terminal, the problem of the overheating of the product caused by the heat generation of the built-in battery is avoided, the safety of the device is enhanced, and the user's experience is better.

### Embodiment 2

The present embodiment aims to further prolong the duration of the cooperative use of the head-wearable display device and the portable terminal. FIG. 2 is functional block diagram of a head-wearable displaying and powering system according to a second embodiment of the present disclosure. As shown in FIG. 2, in the head-wearable displaying and powering system according to the present embodiment, the head-wearable display device 210 is still, as in the first embodiment, connected to one communication interface 221 disposed on the portable terminal 220 through a communication interface 211 to implement connection of the head-wearable display device 210 and the portable terminal 220.

The difference is that a wireless charging receiving module 222 is disposed in the portable terminal 220. The head-wearable displaying and powering system according to the present embodiment further comprises a wireless powering device 230. The wireless powering device 230 may power the portable terminal 220 to thereby prolong the duration of the cooperative use of the head-wearable display device 210 and the portable terminal 220.

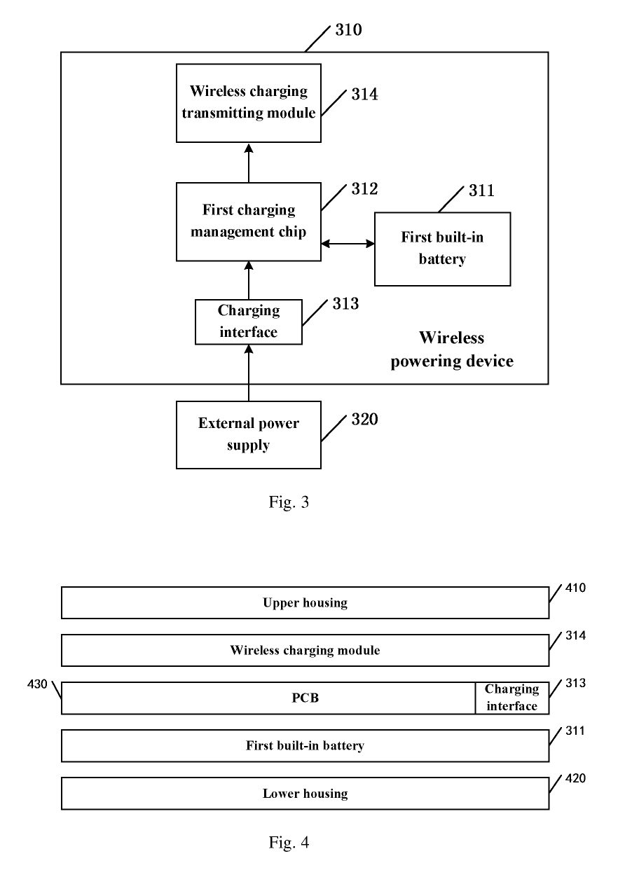

FIG. 3 is a functional block diagram of a wireless charging device in the head-wearable displaying and powering system according to an embodiment of the present disclosure, and FIG. 4 is a structural schematic view of a wireless charging device in the head-wearable displaying and powering system according to an embodiment of the present disclosure. In conjunction with FIG. 3 and FIG. 4, a wireless powering device 310 comprises a housing consisting of an upper housing 410 and a lower housing 420, a PCB 430 and a first built-in battery 311 are disposed in the housing, the PCB 430 is provided with a first charging management chip 312 and a charging interface 313, and the charging interface 313 is exposed out of the housing to connect with an external power supply 320. A wireless charging transmitting module 314 is further disposed in the housing and used to power the portable terminal provided with the wireless charging receiving module.

Preferably, as shown in FIG. 4, the wireless charging transmitting module 314 is disposed at a location above the PCB 430 and adjacent to the upper housing 410. When the wireless charging device is used to power the portable terminal, the portable terminal is placed on an outer surface of the upper housing 410 of the wireless charging device, the wireless charging transmitting module 314 is disposed at a location adjacent to the upper housing 410 so that the wireless charging transmitting module 314 is closer to the wireless charging receiving module in the portable terminal and less obstacles exist therebetween, the signal transmitted by the wireless charging transmitting module 314 may be more received by the wireless charging receiving module, and the electrical energy loss while the wireless powering device 310 charges the portable terminal is reduced.

Preferably, still as shown in FIG. 4, the first built-in battery 311 is disposed at a location below the PCB 430 and adjacent to the lower housing 420. The heat generated while the first built-in battery 311 is working may be dissipated to the external of the wireless powering device 310 via the lower housing 420 as quickly as possible so that the wireless powering device 310 exhibits a better heat dissipation performance. Furthermore, when the wireless powering device 310 is working, the distance of the first built-in battery 311 away from the portable terminal is further, which prevents a lot of the heat generated by the first built-in battery 311 from being transferred to the portable terminal and affecting the normal operation of the portable terminal.

In the present embodiment, while the charging interface 313 is not connected to an external power supply 320, the first charging management chip 312 controls the first built-in battery 311 to power the wireless charging transmitting module 314, namely, the electrical energy provided by the first built-in battery 311 is used to power the portable terminal provided with the wireless charging receiving module.

While the charging interface 313 is connected to an external power supply 320, the first charging management chip 312 controls the external power supply 320 to directly power the wireless charging transmitting module 314, whereupon the electrical energy of the first built-in battery 311 is not consumed any longer and the service life of the first built-in battery 311 is prolonged. Meanwhile, the first charging management chip 312 further uses the electrical energy provided by the external power supply 320 to charge the first built-in battery 311 and prolong the continued use duration of the first built-in battery 311.

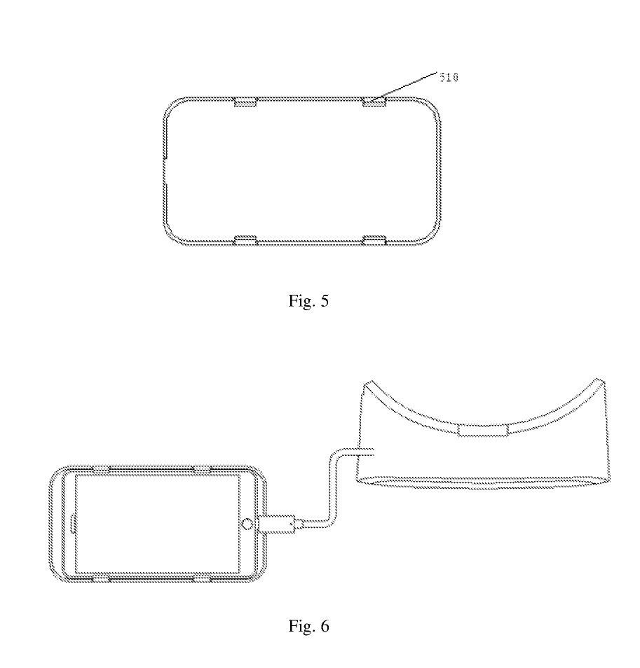

FIG. 5 is a view showing appearance of a wireless charging device in the head-wearable displaying and powering system according to an embodiment of the present disclosure, and FIG. 6 is a structural schematic diagram of the head-wearable displaying and powering system according to an embodiment of the present disclosure. In conjunction with FIG. 5 and FIG. 6, in the preferred embodiments of the present disclosure, the wireless powering device is a battery back clip, the portable terminal is a device such as a mobile phone or flat panel computer supporting the wireless charging function, and a wireless charging receiving device is disposed in the portable terminal. The wireless powering device has a shape matching the portable terminal. An edge of the upper housing of the wireless powering device is provided with a fixing structure 310 which may fix the wireless powering device to a back side of the portable terminal so that the wireless powering device is portable. Furthermore, during movement, the upper housing of the wireless powering device is in close contact with the back side of the portable terminal forever, and the wireless charging receiving module may better receive a signal transmitted by the wireless charging transmitting module and reduce the electrical energy loss while the wireless powering device supplies power to the portable terminal. The wireless powering device according to the present embodiment has an external shape like a protective housing, functions to power the portable terminal as well as protect the housing, and may protect the portable terminal such as a mobile phone or a flat panel computer. That is to say, the powering device serves as the protective housing and the external battery of the portable terminal.

In addition, an end face of the housing of the wireless powering device may be provided with a Micro USB type charging interface through which the external power supply is connected. The electrical energy provided by the external power supply is used to charge the battery of the wireless powering device, and the electrical energy provided by the external power supply is used to, via the wireless charging transmitting module, directly power the portable terminal provided with the wireless charging receiving module to further prolong the duration of the cooperative use of the portable terminal and the head-wearable display device.

Preferably, still as shown in FIG. 1, the head-wearable display device 100 is further provided with a power supply module 108. When the head-wearable display device 100 is connected to the communication interface 301 of the portable terminal 300 via the communication interface 101, the power supply module 108 obtains the working power supply from the portable terminal 300 to power the modules in the head-wearable display device 100.

Further preferably, in the head-wearable display device 100 are further provided a second charging management chip 109 and a second built-in battery 110. The second charging management chip 109 is connected with the communication interface 101, the second built-in battery 110 and the power supply module 108.

When the head-wearable display device 100 is connected with the communication interface 301 of the portable terminal 300 via the communication interface 101, the second charging management chip 109 takes power from the portable terminal 300 to charge the second built-in battery 110.

When the head-wearable display device is not connected with the communication interface 301 of the portable terminal 300 via the communication interface 101, the second charging management chip 109 takes power from the second built-in battery 110 to power the power supply module 108 so that the head-wearable display device has a self-powering capability and may prolong, to a certain degree, the duration of the cooperative use of the head-wearable display device and the portable terminal. The powering system according to the present disclosure mainly uses the portable terminal to power the head-wearable display device. Usually, the second built-in battery 110 has a small capacity, which is mainly intended to prevent the accidental disconnection between the head-wearable display device and the powering device and prevent device malfunction that might be caused by sudden power failure of the head-wearable display device. Therefore, the second built-in battery 110 does not cause the problem that the superheat of the device affects the user's experience.

To conclude, in the head-wearable displaying and powering system according to the present disclosure, the head-wearable display device is provided with one communication interface, and connected to the portable terminal via the interface. The head-wearable display device, through the communication interface, simultaneously acquires audio and video data from the portable terminal, exchanges data with the portable terminal and acquires the working power supply from the portable terminal. The head-wearable display device does not require an additional power supply interface or power supply line, makes the product more pleasant and reduces the costs. The head-wearable display device may operate normally after being connected to the portable terminal only via one communication interface, needn't occupy too many communication interfaces on the portable terminal and does not limit the application of the portable terminal. As the head-wearable display device acquires the working power supply mainly from the portable terminal, the problem of the overheating of the product caused by the heat generation of the built-in battery is avoided, the safety of the device is enhanced, and the user's experience is better.

Secondly, the head-wearable displaying and powering system according to the present disclosure further provides a wireless charging device, which powers the portable terminal in which the wireless charging receiving module is built, and further prolongs the duration of the cooperative use of the portable terminal and the head-wearable display device. Since power is supplied in a wireless manner, the wireless powering device does not occupy an interface of the portable terminal, does not affect the cooperative use of the head-wearable display device and the portable terminal, and does not limit the application of the portable terminal.

Finally, the wireless powering device is a battery back clip which is shaped to match the portable terminal, and the powering device may be fixed to the back side of the portable terminal through a fixing structure disposed on edges of the upper housing of the powering device, thereby enhancing the overall portability of the head-wearable displaying and powering system.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A head-wearable displaying and powering system, comprising a head-wearable display device and a portable terminal; wherein the head-wearable display device is provided with one communication interface through which the head-wearable display device is connected to the portable terminal;
when the head-wearable display device is connected to the portable terminal, the portable terminal, through the communication interface, transmits audio and video data to the head-wearable display device, exchanges data with the head-wearable display device and provides the working power supply to the head-wearable display device.

2. The head-wearable displaying and powering system according to claim 1, wherein the communication interface is a USB Type-C interface, and the portable terminal is a smart mobile phone or flat panel computer having the USB Type-C interface.

3. The head-wearable displaying and powering system according to claim 2, wherein the communication interface is a cabled USB Type-C male plug, and the portable terminal is provided with a USB Type-C female receptacle.

4. The head-wearable displaying and powering system according to claim 3, wherein a wireless charging receiving module is disposed in the portable terminal, and the head-wearable displaying and powering system further comprises a wireless powering device;
the wireless powering device comprises a housing consisting of an upper housing and a lower housing, in the housing disposed are a wireless charging transmitting module, a PCB and a first built-in battery, the PCB is provided with a first charging management chip and a charging interface, and the charging interface is exposed out of the housing to connect with an external power supply;
the wireless powering device powers the portable terminal via the wireless charging transmitting module.

5. The head-wearable displaying and powering system according to claim 4, wherein the wireless charging transmitting module of the wireless powering device is disposed at a location above the PCB and adjacent to the upper housing, and the first built-in battery is disposed at a location below the PCB and adjacent to the lower housing.

6. The head-wearable displaying and powering system according to claim 5, wherein
when the charging interface of the wireless powering device is not connected with the external power supply, the first charging management chip controls the first built-in battery to power the wireless charging transmitting module;
when the charging interface is connected with the external power supply, the first charging management chip controls the external power supply to directly power the wireless charging transmitting module and simultaneously charge the first built-in battery.

7. The head-wearable displaying and powering system according to claim 6, wherein
the wireless powering device is a battery back clip which is shaped to match the portable terminal; an edge of the upper housing of the wireless powering device is provided with a fixing structure which is used to fix the wireless powering device to a back side of the portable terminal.

8. The head-wearable displaying and powering system according to claim 7, wherein the charging interface of the wireless powering device is a Micro USB interface disposed on an end face of the housing of the wireless powering device.

9. The head-wearable displaying and powering system according to claim 8, wherein in the head-wearable display device is provided a power supply module, and the power supply module is connected to the communication interface;
when the head-wearable display device is connected to the portable terminal through the communication interface, the power supply module obtains the working power supply from the portable terminal and powers modules of the head-wearable display device.

10. The head-wearable displaying and powering system according to claim 9, wherein in the head-wearable display device are further provided a second built-in battery and a second charging management chip, and the second charging management chip is connected with the communication interface, the second built-in battery and the power supply module;
when the head-wearable display device is connected to the portable terminal via the communication interface, the second charging management chip takes power from the portable terminal to charge the second built-in battery;
when the head-wearable display device is not connected with the portable terminal or a power amount of the portable terminal is insufficient, the second charging management chip takes power from the second built-in battery to power the power supply module.
